(19) United States
(12) Patent Application Publication
(10) Pub. No.: US 2023/0288827 A1
(43) Pub. Date: Sep. 14, 2023

(54) PHOTOSENSITIVE BODY INCLUDING PROTECTIVE LAYER

(71) Applicant: Hewlett-Packard Development Company, L.P., Spring, TX (US)

(72) Inventor: JIHOON KIM, GYEONGGI- DO (KR)

(73) Assignee: Hewlett-Packard Development Company, L.P., Spring, TX (US)

(21) Appl. No.: 18/009,883

(22) PCT Filed: Jul. 29, 2020
(86) PCT No.: PCT/US2020/044053

§ 371 Date: Dec. 12, 2022

(51) Int. Cl. G03G 5/147; G03G 21/18

(52) U.S. Cl. CPC G03G 5/14773; G03G 5/14769; G03G 21/18

(57) ABSTRACT

A photosensitive body for an image forming apparatus may include a photosensitive layer and a protective layer formed on the photosensitive layer. The protective layer may include a urethane oligomer-based compound including urethane oligomer acrylates, and a polysiloxane including a silicon atom (Si) covalently bonded to a first side chain including an oxygen atom (O) covalently bonded to the urethane oligomer-based compound. The polysiloxane may have a chemical structure represented by the following Formulae 1:

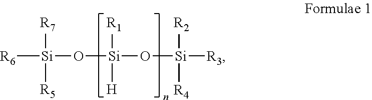

where R1 through R7 each independently represents a hydrogen atom, or alkyl which has 1 to 25 carbons, or the alkoxy group which has 1-10 carbons, where n represents an integer greater than or equal to 1, and where each respective H independently represents a hydrogen atom or the oxygen atom (O) covalently bonded to the urethane oligomer-based compound.

### BACKGROUND

An image forming apparatus may include an electrophotographic image forming apparatus such as a toner printer, a laser printer, a facsimile, a photocopier, and a multifunctional apparatus. An electrophotographic image forming apparatus may include a photosensitive body, and a charging roller, a developing roller, a transfer roller and the like installed on the circumference of the photosensitive body. A toner supplied from a developing device may be transferred by voltage applied to a photosensitive body, a charging roller, a developing roller or a transfer roller to form a predetermined image in a printed medium.

For example, a charging roller charges the surface of a photosensitive body with a predetermined voltage, and light scanned in a light exposure unit forms an electrostatic latent image corresponding to print data on the charged surface of the photosensitive body. Then, a developing roller supplies the photosensitive body with a toner to develop the electrostatic latent image into a toner image. The toner image is transferred to a print medium passing between the photosensitive body and a transfer roller by the transfer roller.

### BRIEF DESCRIPTION OF THE DRAWINGS

FIG. 1 is a structure of an image forming apparatus according to an example;

FIG. 2 is a cross-sectional view of layers in a photosensitive body according to an example;

FIG. 3 indicates illustrations of residual surface potential of protective layer examples after being exposed to light energy;

FIGS. 4A and 4B are examples of printing results indicating contrast gradients; and

FIGS. 5A and 5B indicate examples surfaces of a protective layer in the photosensitive body according an example.

### DETAILED DESCRIPTION

Reference will now be made in detail to examples, examples of which are illustrated in the accompanying drawings. The disclosure according to an example may be variously modified to various other examples. In this disclosure, when the specification states that one constituent element is “connected to” another constituent element, it includes a case in which the two constituent elements are connected to each other with another constituent element intervened therebetween as well as a case in which the two constituent elements are directly connected to each other. As used herein, the term “and/or” includes any and all combinations of one or more of the associated listed items. Expressions such as “at least one of,” when preceding a list of elements, modify the entire list of elements and do not modify the individual elements of the list. Terms used in the specification, “first”, “second”, etc. may be used to describe various components, but the components are not to be interpreted to be limited to the terms, as These terms are only used to differentiate one component from other components.

According to an example, the expression “image forming apparatus” as used herein includes an apparatus that processes printing data generated at a terminal such as a computer communicating through a wired connection or wirelessly, which may be a computer for personal and/or business use, a remote server communicating data across a network or the Internet, and/or a wireless mobile device such as a smartphone or tablet, to perform printing. Examples of the printing apparatus may include particulate-based printing apparatuses.

An image forming apparatus may include a photosensitive body that is to form and carry electrostatic pattern based on an image by holding various residual charge potential levels VL on its surface after being exposed to light having an amount of energy (e.g., in μJ/cm²). The photosensitive body may be distressed and wear out by electrical potential stress by charging and light exposure, and also possibly by development, transfer, cleaning, and by mechanical stresses exerted by contact with another object such as another roller and/or a cleaning blade. Accordingly, a photosensitive body may be designed to increase its durability and/or operating life, for example, by having a protective layer. For example, by having a protective layer, durability may be increased against deterioration of potential characteristics by ozone or charging.

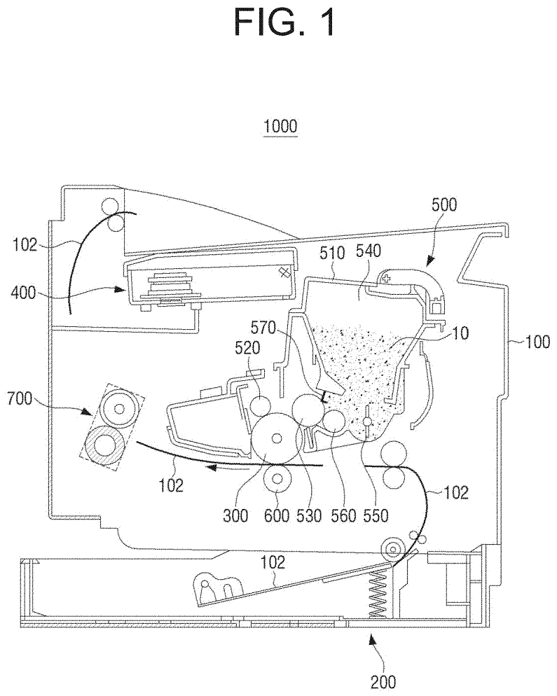

According to an example, FIG. 1 illustrates an image forming apparatus 1000 including a photosensitive body 300.

Referring to FIG. 1, the image forming apparatus 1000 according to an example may include a body case 100, and a paper supplier 200, a photosensitive body 300, an optical scanner 400, a development cartridge 500, a transfer roller 600, and a fixer 700.

The body case 100 forms the exterior of the image forming apparatus 1000. The paper supplier 200 may be provided inside of the body case 100, and in this paper supplier 200, paper 102 may be loaded.

The photosensitive body 300 has a cylindrical drum shape extended to a predetermined length to correspond to the width of the paper 102. The photosensitive body 300 may be charged at constant polarity potential by a charging roller 520. On the photosensitive body 300 of which the outer circumferential surface may be evenly charged, an electrostatic latent image by potential difference may be formed by a beam scanned from the optical scanner 400. To the electrostatic latent image, a toner 10 may be supplied by a developing roller 530, and the image by the toner 10 may be transferred on the paper 102 passing between the photosensitive body 300 and the transfer roller 600.

The optical scanner 400 may scan a beam corresponding to the image data to be formed on the paper 102 to the photosensitive body 300, to form the electrostatic latent image on the photosensitive body 300. The optical scanner 400 may include a light scanner such as a scanner using a laser diode, LED, or other various types of a light source. According to an example, light sources may various shapes.

The development cartridge 500 may supply the toner 10 which may be a toner to the electrostatic latent image of the photosensitive body 300. The development cartridge 500 may include a cartridge case 510, and the charging roller 520, the developing roller 530, a toner storage 540, a hopper 550, a feed roller 560, and a regulating blade 570.

The charging roller 520 may rotate in contact with the photosensitive body 300, and may charge the surface of the photosensitive body 300 at a relatively consistent or uniform potential value. The developing roller 530 may supply the toner 10 to the electrostatic latent image formed on the photosensitive body 300. The toner storage 540 may be formed inside of the cartridge case 510, and the toner 10 may be stored therein: The hopper 550 may be provided in the toner storage 540. The feed roller 560 may be provided in the toner storage 540, and may supply the toner 10 to the developing roller 530. The regulating blade 570 may be extended from the toner storage 540 to be in contact with the developing roller 530. The charging roller 520 may be provided inside of the cartridge case 510, and rotates in contact with the photosensitive body 300. To the charging roller 520, a charging bias may be applied to charge the outer circumferential surface of the photosensitive body 300 at the same potential value. When a beam from the optical scanner 400 is projected onto a surface of the photosensitive body 300 charged at the relatively consistent surface potential value by the charging roller 520, at the point where the beam and/or light having an energy level (e.g., in μJ/cm²)is projected onto the surface, the potential value VL may be changed due to the photoconductive property of the photosensitive body 300. Therefore, a potential difference occurs between the point where the beam is scanned and the point where the beam is not scanned, thereby forming an electrostatic latent image on the photosensitive body 300 by the potential difference. The developing roller 530 may be installed close to the toner storage 540 to rotate in an opposite direction to the rotation direction of the photosensitive body 300. The developing roller 530 to which a developing bias may be applied rotates in contact with the feed roller 560, and the toner 10 from the feed roller 560 may be attached thereto by the potential difference with the feed roller 560. The developing roller 530 to which the toner 10 is attached rotates in contact with the photosensitive body 300, so that the attached toner 10 may be supplied to the electrostatic latent image of the photosensitive body 300. The toner storage 540 may be formed as a housing space for storing the toner 10 inside of the cartridge case 510. In the toner storage 540, one side where the developing roller 530 is provided may be opened, thereby supplying the stored toner 10 to the developing roller 530 by the feed roller 560. At least one hopper 550 may be installed in the toner storage 540. The hopper 550 rotates in the toner storage 540, conveys the toner 10 toward the feed roller 560, and stirs the toner 10, thereby preventing solidification of the toner 10 and improving flowability. In addition, the hopper 550 stirs the toner 50, thereby allowing the toner 10 to be charged at a predetermined potential value. The feed roller 560 may be provided on the lower side of the toner storage 540 to rotate in contact with the developing roller 530. The feed roller 560 supplies the toner 10 conveyed by the hopper 550 to the developing roller 530. The feed roller 560 rotates in the same direction as the developing roller 530, that is, in a crossing direction to each other. In this way, the toner 10 passing between the feed roller 560 and the developing roller 530 to receive frictional force may be charged at a predetermined potential value and simultaneously attached to the developing roller 530 in an appropriate amount. The regulating blade 570 may be in contact with the developing roller 530 with a predetermined pressurizing force. In this way, the regulating blade 570 secures the uniformity of the amount of the toner 10 supplied from the feed roller 560 and attached to the developing roller 530, that is, the mass of the toner 10 per unit area of the developing roller 530 (M/A [g/cm²]). In addition, the regulating blade 570 charges the toner 10 attached to the developing roller 530 at a predetermined potential value. For this, the regulating blade 570 may be provided to include a conductive material, and have a constant potential value by applying a power supply thereto.

The transfer roller 600 may rotate in contact with the photosensitive body 300 so that an image by the toner 10 may be transferred on the paper 102. The fixer 700 fixes the image by the toner 10 on the paper 102.

According to an example, the photoreceptor according to an example has a laminate type electrophotographic photoreceptor structure in which an undercoat layer, a charge generation layer, and a charge transport layer are sequentially formed on an electrically conductive substrate.

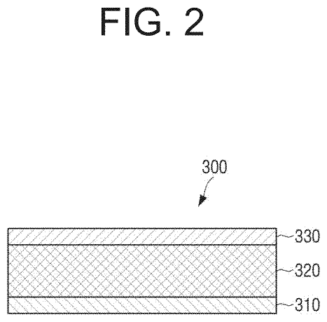

For example, FIG. 2 represents a cross-sectional view of layers in the photosensitive body according to an example.

Referring to FIG. 2, the photosensitive body 300 may include a support 310, a photosensitive layer 320, and a protective layer 330.

According to an example, the electrically conductive substrate may be in the form of a plate, disc, sheet, belt, drum, or the like which may include any conductive material, for example, a metal or an electrically conductive polymer. For example, referring to FIG. 2, the shape of the support 310 may be varied to be, for example, a cylindrical or endless belt shape.

According to an example, the support 310 may include a conductive material. For example, the conductive material may include metal materials such as aluminum, an aluminum alloy, vanadium, nickel, copper, zinc, silver, gold, stainless steel, palladium, indium, tin, platinum, titanium, or the like. For example, the electrically conductive material may include a polymer such as a polyester resin, a polycarbonate resin, a polyamide resin, a polyimide resin, and any mixture thereof, or a copolymer of monomers used in preparing the resins described above in which an electrically conductive material such as metal particles, a conductive carbon, tin oxide, indium oxide, or the like may be dispersed. For example, an organic polymer sheet or glass sheet on which a metal is deposited or a metal sheet is laminated may be used as the electrically conductive substrate. For example, the conductive material may be obtained by laminating or depositing a metal film such as films of aluminum, an aluminum alloy, copper, zinc, silver, gold, stainless steel or titanium, or depositing or coating a layer of a conductive metal oxide such as a conductive polymer, tin oxide, indium oxide or indium tin oxide, on the surface of polyester such as polyethylene terephthalate, nylon such as nylon 6 and nylon 66, and polymer materials such as polystyrene, polycarbonate, a phenol resin and polyimide, hard paper, glass, or the like, may be used. For example, a conductive path formed by including the particles of the metal material or the conductive metal oxide in the polymer material may be used.

The surface of the support 310 may, for example, undergo a positive electrode oxide coat treatment, surface treatment by chemicals, hot water or the like, coloring treatment, or diffuse treatment such as roughening the surface, to the extent not affecting image quality. In the electrophotographic process using a light exposure source such as a laser or a LED, incident light and reflected light in an organic photosensitive body may cause interference, and an interference pattern by this interference occurs on the image to cause an image defect. By carrying out the above-described treatment on the surface of the support 310, the image defect by the interference of laser light may be reduced or suppressed.

According to an example, an intermediate layer may be further included to maintain the electrical properties of the photosensitive body between the photosensitive layer 320 and the support 310. The intermediate layer may be formed on the support 310, and serves to improve image characteristics by hole injection inhibition, improve adhesion of the support 310 and the photosensitive layer 320, prevent damages such as dielectric breakdown of the photosensitive layer.

The photosensitive layer 320 may be formed of a laminated structure of a charge generation layer containing a charge generating material, and a charge transport layer containing a charge transporting material. As such, each layer is responsible for a charge generation function and a charge transport function, thereby selecting an optimal material for each function of charge generation and charge transport. Therefore, a photosensitive body having higher sensitivity and high durability with excellent stability during repeated use may be obtained.

The charge generation layer may contain a charge generating material to generate charge.

As a material that can be effective for the charge generating material, a variety of material types may be implemented, such as an azo-based pigment such as a monoazo-based pigment, a bisazo-based pigment and a trisazo-based pigment; an indigo-based pigment such as indigo and thioindigo; a perylene-based pigment such as perylene imide and perylenic acid anhydride; a polycyclic quinone-based pigment such as anthraquinone and pyrenequinone; a phthalocyanine-based pigment such as metal phthalocyanine and non-metal phthalocyanine; a squarylium coloring agent; pyrylium dyes and thiopyrylium dyes; a triphenylmethane-based coloring agent; inorganic materials such as selene and amorphous silicon. According to an example, these charge generating materials may be used alone or in combination of two or more.

According to an example, the charge generation layer may have a film thickness fo a stable performance of the charge generation layer. For example, the charge generation layer may have a film thickness of about 0.05 μm or more and about 5 μm or less; specifically about 0.1 μm or more and about 1 μm or less. When the charge generation layer has a film thickness less than about 0.05 μm, light absorption efficiency may be reduced to lower sensitivity. When the charge generation layer has a film thickness more than about 5 μm, charge transfer inside of the charge generation layer may become a rate limiting step of a process in removing charge on the surface of the photosensitive body, thereby decreasing sensitivity.

According to an example, the charge transport layer contains a charge transport material having a transport ability by accepting charge generated in the charge generating material.

According to an example, the charge transport layer may include a charge transporting material and a binder compound to hold or bind the charge transporting material, such as a binder resin. According to an example, the charge transporting material may be to function to form an electrostatic latent image by transferring holes generated from the charge generation layer to a surface of the charge transport layer through a conductive path formed in the charge transport layer by light exposure. According to an example, the charge transporting material may include a hole transporting material for transporting holes and/or an electron transporting material for transporting electrons. When the laminate type photoreceptor may be used as a negatively charged type, the hole transporting material may be used as a major component of the charge transporting material. In this case, a small amount of the electron transporting material may be added thereto in order to prevent a hole trap. A content of the electron transporting material may be in a range of about 0 to 50 parts by weight, for example, about 5 to 30 parts by weight.

According to an example, a variety of types of materials can be used to optimze or increase the performance of the charge transporting material. For example, the charge transporting material may include the hole transporting material which may be included in the charge transport layer, which may be nitrogen containing cyclic compounds or condensed polycyclic compounds such as a hydrazone-based compound, a butadiene-based compound, a benzidine-based compound, a stilbene-based compound, a bisazo-based compound, a pyrene-based compound, a carbazole-based compound, an arylmethane-based compound, a thiazol-based compound, a styryl-based compound, a pyrazoline-based compound, an arylamine-based compound such as a diphenylamine-based compound and triphenylamine-based compound, an oxazole-based compound, an oxadiazole-based compound, a pyrazoline-based compound, a pyrazolone-based compound, a polyaryl alkane-based compound, a polyvinylcarbazole-based compound, a N-acrylamide methylcarbazole copolymer, a triphenylmethane copolymer, a styrene copolymer, polyacenaphthene, polyindene, a copolymer of acenaphthylene and styrene, a formaldehyde-based condensed resin, and/or a high molecular weight compound having substituents of the above compounds in a main chain or a side chain. For example, the charge transport material may include a carbazole derivative, a butadiene derivative, an oxazole derivative, an oxadiazole derivative, a thiazole derivative, a thiadiazole derivative, a triazole derivative, an imidazole derivative, an imidazolone derivative, an imidazolidine derivative, a bisimidazolidine derivative, a styryl compound, a hydrazone compound, a polycyclic aromatic compound, an indole derivative, a pyrazoline derivative, an oxazolone derivative, a benzimidazole derivative, a quinazoline derivative, a benzofuran derivative, an acridine derivative, a phenazine derivative, an aminostilbene derivative, a triarylamine derivative, a triarylmethane derivative, a phenylenediamine derivative, a stilbene derivative, a benzidine derivative, and the like may be listed. In addition, a polymer having a moiety derived from these compounds in a straight chain or branched chain, for example, poly-N-vinyl carbazole, poly-1-vinylpyrene, poly-9-vinylanthracene and the like may be used. According to an example, the above-listed hole transporting material compound may be used alone or in combination of two or more.

According to an example, when the electron transporting material is included in the charge transporting material, a variety of types of a usable electron transporting material can be implemented for the performance of the photosensitive body. According to an example, the electron transporting material may include low molecular weight compounds for electron transporting such as a benzoquinone-based compound, a naphthoquinone-based compound, an anthraquinone-based compound, a malononitrile-based compound, a diphenoquinone-based compound, a fluorenone-based compound, a cyanoethylene-based compound, a cyanoquinodimethane-based compound, a xanthone-based compound, a phenanthraquinone-based compound, a phthalic anhydride-based compound, a thiopyran-based compound, a dicyanofluorenone-based compound, a naphthalenetetracarboxylic add diimide compound, a benzoquinoneimine-based compound, a stilbenequinone-based compound, a diiminoquinone-based compound, a dioxotetracenedione compound, and a pyran sulfide-based compound. In addition, an electron transporting polymer compound or a pigment having n-type semiconductor characteristics may be used. The foregoing electron transporting materials may be used alone or in combination of two or more.

Examples of the hole transporting material may include 1,1-bis-(para-diethylaminophenyl)-4,4-diphenyl-1,3-butadiene, N,N′-bis(ortho,para-dimethylphenyl)-N,N′-diphenylbenzidine, 3,3′-dimethyl-N,N,N″,N″-tetrakis-4-methylphenyl-(1,1′-biphenyl)-44-diamine, N-ethyl-3-carbozolylaidehyde-N,N′-diphenylhydrazone, 4-(N,N-bis(para-toluyl)amino)-betaphenylstilbene, N,N,N′,N′-tetrakis(3-methylphenyl)-1,3-diaminobenzene, N,N-diethylaminobenzaldehydediphenyl-hydrazone, N,N-dimethylaminobenzaldehydediphenyl-hydrazone, 4-dibenzylamino-2-methylbenzaldehydediphenylhydrazone, 2,5-bis(4-aminophenyl)-[1,3,4]oxadiazole, (2-phenylbenzo[5,6-b]-4H-thiopyran-4-ylidene)-propanedinitrile-1, 1-dioxide, 4-bromo-triphenylamine, 4,4′-(1,2-ethanediylidene)-bis(2,6-dimethyl-2,5-cyclohexadiene-1-one), 3,4,5-triphenyI-1,2,4-triazole, 2-(4-methylphenyl)-6-phenyl-4H-thiopyran-4-ylidene-propanedinitrile-1,1-dioxide, 4-dimethylamino-benzaldehyde-N,N-diphenylhydrazone, 9-ethylcarbazole-3-aldehyde-N-methyl-N-phenylhydrazone, 5-(2-chlorophenyl)3-[2-(2-chlorophenyl)ethenyl]-1-phenyl-4,5-dihydro-1H-pyrazole, 4-diethylamino-benzaldehyde-N,N-diphenylhydrazone, N-biphenylyl-N-phenyl-N-(3-methylphenyl)amine, 9-ethylcarbazole-3-aldehyde-N,N-diphenylhydrazone, 3,5-bis(4-tert-butylphenyl)4-phenyltriazole, 3-(4-biphenylyl)-4-phenyl-5-tert-butylphenyl-1,2,4-triazole, 4-diphenylamino-benzaldehyde-N,N-diphenyihydrazone, 5-(4-diethylaminophenyl)-3[2-(4-diethylaminophenyl)-ethenyl]-1-phenyl-4,5-dihydro-1-pyrazole, N,N′-di(4-methylphenyl)-N,N-diphenyl-1,4-phenylenediamine, 4-clibenzylaminobenzaldehyde-N,N-diphenyihydrazone, 4-dibenzylamino-3-methylbenzaldehyde-N,N-diphenylhydrazone, 4,4′-bis(carbazole-9-yl)biphenyl, N,N,N′,N′-tetraphenylbenzidine, N,N′-bis(4-methylphenyl)-N,N′-bis(phenyl)-benzidine, N,N1-bis(3-methylphenyi)-N,N′-bis(phenyl)benzidine, N,N,N′,N′-tetrakis(4-methylphenyl)bezidine, N,N,N′,N′-tetrakis(3-methylphenyl)bezidine, di(4-dibenzylaminophenyl)ether, N,N′-di(naphthalene-2-yl)-N,N′-diphenylbezidine, N,N′-di(naphthalene-1-yl)-N,N′-diphenylbezidine, 1,3-bis(4(4-diphenylamino)phenyl-1,3,4-oxadiazole-2-yl)benzene, N,N′-di(naphthalene-2-yl)N,N′-di(3-methylphenyl)bezidine, N,N′-di(naphthalene-1-yl)-N,N′-di(4-methylphenyl)bezidine, N,N′-di(naphthalene-2-yl)-N,N′-di(3-methylphenyl)bezidine, 1,1-bis(4-bis(4-methylphenyl)aminophenyl)cyclohexane, 4,4′, 4″-tris(carbazole-9-yl)-triphenylamine, 4,4′,4″-tris(N,N-diphenylamino)-triphenylamine, N,N′-bis(biphenyl-1-yl)-N,N′-bis(naphth-1-yl)benzidine, 4,4′, 4″-tris(N-3-methylphenyl-N-phenylamino)triphenylamine, N,N,N′,N′-tetrakis(biphenyl-4-yl)benzidine, 4,4′,4″-tris(N-(1-naphthyl)-N-phenylamino)triphenylamine, and 4,4′,4″-tris(N-(2-naphthyl)-N-phenylamino)triphenylamine. According to an example, these hole transporting materials may be used alone or in combination of two or more.

If the charge transporting material itself has film-forming characteristics, the charge transporting layer may be formed without the binder resin, but usually low molecular materials do not have film-forming characteristics. Therefore, the charge transporting material may be dissolved or dispersed with a binder resin in a solvent to prepare a coating composition (solution or dispersion) for forming a charge transport layer, and then the solution or the dispersion may be coated on the charge generation layer and dried to form the charge transport layer. Examples of the binder resin which may be used for the charge transport layer of the electrophotographic photoreceptor according to an example may include an insulation resin capable of forming a film, such as polyvinyl butyral, polyacrylate (a condensed polymer of bisphenol A and phthalic acid, and so on), polycarbonate, polysulfone, a polyester resin, a phenoxy resin, polyvinyl acetate, an acrylic resin, a polyacrylamide resin, polyimide, polyvinyl pyridine, a cellulose-based resin, a urethane resin; an epoxy resin, a silicone resin; polystyrene, polyketone, polyvinyl chloride; a vinyl chloride-vinyliacetate copolymer, polyvinyl acetal, polyacrylonitrile, a phenolic resin, a melamine resin, casein, polyvinyl alcohol, and polyvinyl pyrrolidone; and an organic photoconductive polymer, such as poly N-vinyl carbazole, polyvinyl anthracene, polyvinyl pyrene, and so on. For example; a polycarbonate resin may be used as the binder resin for a charge transport layer. For example, among the polycarbonate resin, polycarbonate-A derived from bisphenol A or polycarbonate-C derived from methylbisphenol-A, and polycarbonate-Z derived from cyclohexylidene bisphenol may be used. Polycarbonate-Z may have a high wear resistance. These binder resins may be used alone or in combination of two or more.

A solvent used in preparation of a coating composition for forming a charge transport layer may vary according to a type of the used binder resin, and may preferably be selected in such a way that it does not affect the charge generation layer formed underneath. Examples of the solvent may be, for example; hydrocarbons such as hexane, aromatic hydrocarbons such as benzene, xylene, ligroin, monochlorobenzene, and dichlorobenzene; ketones such as acetone, methyl ethyl ketone, and cyclohexanone; alcohols such as methanol, ethanol; and isopropanol; esters such as ethyl acetate and methyl cellosolve; halogenated aliphatic hydrocarbons such as carbon tetrachloride, chloroform, dichloromethane, dichloroethane, and trichloroethylene; ethers such as tetrahydrofuran (THF), dioxane, dioxolan, ethylene glycol, and monomethyl ether; amides such as N,N-dimethyl formamide, N,N-dimethyl acetamide; and sulfoxides such as dimethyl sulfoxide. The foregoing solvents may be used alone or in combination of one or two.

According to an example, the protective layer 330 may be formed on the photosensitive layer 320 to protect the photosensitive layer. According to an example, a variety of methods forming the protective layer 330 can be employed.

For example, the protective layer 330 may be attached to, bonded to, and/or adhered to the photosensitive layer 320. For example, the protective layer 330 may be formed by coating a protective layer composition solution formed of a curable compound curable by a chemical reaction, such as a photo-curable compound, heat-curable, and/or compounds curable by mixing two or more compounds. According to an example, the protective layer composition solution for forming the protective layer 330 may include other ingredients. For example, the protective layer composition solution may be a mixture of different materials. For example, the protective layer solution may be a mixture including electron transfer material or particles, photo-curable material, and/or other materials. According to an example, the protective layer composition solution as the mixture may be prepared by mixing separate sub-mixtures, such as a first sub-mixture including electron transfer material or particles, a second sub-mixture including photo-curable material, and/or another sub-mixture.

According to an example, the protective layer composition solution may include a curable material, a crosslinking agent or hardener, a curing initiator, conductive material as electron transfer material, a polymer dispersant, synergist, a photoinitiator, a water-repellent, a solvent, surface leveling agent, and/or other chemicals. For example, the first sub-mixture as an electron transfer solution may include conductive material or particles as electron transfer material, dispersant to disperse the conductive material or particles such as a polymer-based dispersant, a synergist, a solvent, and/or other material. The second sub-mixture as a curable solution may include curable material. For example, the curable solution may include an oligomer, or a monomer, or both the oligomer and the monomer. For example, the curable solution may include curing initiator such as a photo-initiator, a leveling agent, a water-repellent, a solvent, and/or other material.

According to an example, the protective layer composition solution may be coated on the surface of the photosensitive layer 320, and then carrying out a curing process, such as photocuring, thermal curing, or reaction curing. For example, the curing process can be facilitated by ultraviolet light.

According to an example, as the photocurable material may include a monomer, dimer, trimer or an oligomer, or any combination thereof, such as an oligomer and a monomer, where the monomer and/or the oligomer has a reactive site such as an unsaturated bond group, such as a functional group having a crosslinkable unsaturated bond group, may be used. According to an example, the reactive site may refer to a group involved in a curing reaction, such as a photocuring reaction including a crosslinking reaction by UV irradiation, heat-curing reaction or another curing reaction.

According to an example, a variety of types of a pre-polymer, monomer, dimer, trimer and/or different types of oligomers may be included in a curable compound, where one type may be used alone or two or more types can be used in combination. For example, a monomer or an oligomer such as urethane acrylate and lower molecular weight urethane acrylate may be used alone or in combination for curing, which can be facilitated with or without an initiator such as a photoinitiator. For example, a curable compound may include a combination of a curable compound that will react with each other. For example, a monomer can be used along with an oligomer to modify the property of the oligomer in the cured state, for example, to modify or reduce the viscosity, or to modify or adjust elasticity, hardness, and/or other physical properties of the cured compound. For example, the curable compound may include a first compound such as an oligomer having an oxygen atom in a functional group, or a second compound such as a monomer, dimer, trimer or another oligomer, which have an oxygen atom in a functional group, or a combination of an oligomer having an oxygen atom in a functional group and a monomer, an oligomer and a monomer having an oxygen atom in a functional group, or an oligomer having an oxygen atom in a functional group and a monomer having an oxygen atom in a functional group. For example, the curable compound may include a compound having a hydroxyl group (—OH), such as an oligomer having a hydroxyl group (—OH) in a functional group, or a monomer having a hydroxyl group (—OH) in a functional group, or a combination of an oligomer having a hydroxyl group (—OH) in a functional group and a monomer, an oligomer and a monomer having a hydroxyl group (—OH) in a functional group, or an oligomer having a hydroxyl group (OH) in a functional group and a monomer having a hydroxyl group (OH) in a functional group.

According to an example, the urethane oligomer acrylate included in the protective layer 330 may include a mixture of urethane oligomer acrylates having the different number of functional groups from each other. For example, the urethane oligomer acrylate may include a difunctional urethane oligomer acrylate, a trifunctional, and/or urethane oligomer acrylate with higher number of funcationality, for example, to control hardness and toughness, as compared with using the urethane oligomer acrylate having the certain number of functional groups alone. For example, in the case of using a hexafunctional urethane oligomer acrylate alone, light exposure potential rise may be caused by unduly increased hardness of the protective layer, and in the case of using a difunctional urethane oligomer acrylate alone, toner filming may be caused by unduly increased toughness.

According to an example, the urethane oligomer acrylate may be selected from those having a weight average molecular weight of 450 to 2500. For example, the urethane oligomer acrylate may have a weight average molecular weight from about 1000 to about 1350.

According to an example, the photocurable compound for the protective layer 330 according to an example may include a urethane dimmer acrylate and/or a modified perfluoropolyether acrylate monomer, as the photocurable compound. For example, the urethane oligomer acrylate may contain a functional group other than a urethane bond group, such two or more functional groups in addition to a urethane bond. For example, in this case, the urethane oligomer acrylate may be a urethane oligomer having a functional group containing oxygen atom such as hydroxyl (—OH) group. For example, the urethane oligomer may be an aliphatic urethane oligomer acrylate which does not contain including a functional group containing an oxygen atom such as a hydroxyl group (—OH),

According to an example, the protective layer 330 according to an example may include an aliphatic hydrocarbon acrylate having more carbon atoms to increase by using the aliphatic hydrocarbon acrylate having more carbon atoms, water repellency may be increased.

For example, the curable compound may include acrylates such as methacrylates. For example, the curable compound may include an acrylate having a functional group including an oxygen atom, such as hydroxyl group (—OH), e.g., a methacrylate having a functional group including an oxygen atom such as hydroxyl group (—OH). For example, an example of this a photocurable compound may include a urethane acrylate. Such a urethane acrylate may include aliphatic urethane acrylates such as aliphatic urethane multi-acrylate, which may be aliphatic urethane hexaacrylate, aromatic urethane decaacrylate, waterborne aliphatic urethane multi-acrylate such as waterborne aliphatic urethane hexaacrylate, polyester acrylate, dipentacrythritol hexaacrylate, dipentacrythritol pentaacrylate, pentacrythritol tetraacrylate, dipentaerythritol hexaacrylate, dipentaerythritol pentaacrylate, and other acrylate-based compound. According to an example, the acrylate mentioned in the present specification may include acrylates and methacrylates.

For example, urethane oligomer acrylate may include aliphatic urethane hexaacrylate, aliphatic urethane multi-acrylate, aromatic urethane decaacrylate, waterborne aliphatic urethane multi-acrylate, and/or waterborne aliphatic urethane hexaacrylate.

For example, acrylate monomer may include dipentaerythrtiol hexaacrylate DPHA and/or dipentaerythrtiol pentaacrylate DPHA.

According to an example, a photoinitiator used in the protective layer composition solution may include a variety of materials suitable for facilitating the photo-curing for the protective layer 330 according to an example. For example, the photoinitiator may be an actinic ray generating an active species capable of initiating polymerization of the above-described photocurable material by exposure to light such as visible light, ultraviolet ray, far ultraviolet ray and charged particle ray. For example, an O-acyloxime-based compound, an acetophenone-based compound, a biimidazole-based compound, a benzoin-based compound, a benzophenone-based compound, an α-diketone-based compound, a polynuclear quinone-based compound, a xanthene-based compound, a phosphine-based compound, a triazine-based compound and the like may be listed. For example, a photoinitiator may be 1-hydroxycyclohexyl phenyl ketone.

According to an example, the protective layer 330 may further include conductive particles, such as metal particles and/or conductive metal oxide particles.

According to an example, a variety of conductive particle types may be used, such as one or more types of materials selected from copper, tin, aluminum, indium, silica, tin oxide, zinc oxide, titanium dioxide, aluminum oxide (Al₂O₃), zirconium oxide, indium oxide, antimony oxide, bismuth oxide, calcium oxide, Antimony-doped tin oxide (antimony tin oxide, ATO) and carbon nanotubes.

The protective layer 330 may be formed by coating, drying and photocuring of the protective layer composition solution on the photosensitive layer. The coating method may not be particularly limited, and dip coating, spray coating, spin coating, wire bar coating, ring coating and the like in the art may be used. After evaporating the solvent by drying it after coating, photocuring may be carried out by using a photocuring system such as, for example, ultraviolet curing. When the actinic ray is irradiated, radicals are generated to cause polymerization, and intermolecular and intramolecular crosslinking may be formed by the crosslinking reaction occurring intermolecularly and intramolecularly to form a curing product. As the actinic ray, an ultraviolet ray or electron beam may be used, and as the irradiator, an ultraviolet ray irradiator or an electron ray irradiator in the art may be properly used to form the protective layer. According to an example, the photosensitive body 300 may be rotated for more uniform or more consistent curing.

As discussed above, according to an example, the photosensitive body 300 may include the support 310, the photosensitive layer 320, and the protective layer 330, where the photosensitive layer 320 may include a charge generation layer containing a charge generating material, and a charge transport layer containing a charge transporting material. When the photosensitive layer 320 includes a material that can be relatively more dissolvable in a non-polar solvent, such as polycarbonate, the protective layer 330 may include a material that is relatively more polar or more hydrophilic, which can be formed with a relatively more polar solvent such as an alcohol solvent that does not relatively dissolve the material in the photosensitive layer 320. For example, when a polycarbonate-based resin is included in the photosensitive layer 320, which can be relatively more soluble in a non-polar solvent, using a more hydrophilic resin along with alcohol solvent to form the protective layer 330 may not cause dissolving the polycarbonate as much as other relatively more non-polar solvents. For example, for the protective layer 330 forming material, a curing material having a functional group having a relatively more hydrophilic property, such as a functional group including an oxygen atom (e.g., a hydroxyl group (—OH)) may be included in the protective layer 330 as the relatively more hydrophilic material. In this case, when there is a material having a functional group exhibiting relative hydrophilicity, a curing degree may be lowered by the influence of oxygen on the surface during the photocuring process, or degraded image forming quality, such as a missing or blurred image, may be caused by humidity in high temperature and high humidity environment. For example, due to attracting moisture by this relatively more hydrophilic material, a dot-deletion effect during the printing or the image forming may occur. On the other hand, while the protective layer 330 including a material with relatively lower hydrophilicity may reduce image quality degradation due to humidity level, such as dot deletion effect or decreased dot reproducibility, the material with relatively lower hydrophilicity may be less compatible with the photosensitive layer 320 due to the above-discussed reasons. Moreover, Toner filming may occur over time on an outer layer of the photosensitive body when the surface energy of the protective layer 330 is higher due to the relatively more hydrophilic compound.

According to an example, when the curing material included in the protective layer 330 with relatively higher hydrophilicity may include a functional group including an oxygen atom, the relatively higher hydrophilicity may be reduced, by modifying the functional group including the oxygen atom. For example, when the curing material included in the protective layer 330 with relatively more hydrophilic property includes a hydroxyl group, the hydroxyl group may be removed, modified, and/or converted, for example, by replacing the hydrogen atom or OH group with another molecule, such as a molecule capable of exhibiting relatively higher hydrophobicity, and a molecule that is relatively non-polar and/or having a larger portion that can contribute to non-polar characteristics, in which the hydrophilic property contributed by the hydroxyl group may be reduced or converted to be relatively less hydrophilic or relatively more hydrophobic by such a modification.

For example, when the photosensitive layer 320 may include polycarbonate or polycarbonate-based compound, the protective layer 330 may include urethane acrylate-based compound having a hydroxyl group. In this case, according to an example, the protective layer 330 may include a compound or material that is reactable with the hydroxyl group to reduce, decrease, neutralize, or remove the hydrophilicity or polarity by the hydroxyl group, where this compound can function as a water-repellent for the protective layer 330.

According to an example, the compound that is reactable with the hydroxyl group may be a silicon-based compound. For example, the silicon-based compound may include a site including a hydrogen atom that is capable of reacting with the hydroxyl group. For example, the silicon-based compound may include a silicon atom forming a covalent bond with a hydrogen atom. For example, the silicon-based compound may include an alkyl hydrogen silicon oil.

For example, the silicon-based compound may include polysiloxane.

Polysiloxanes are widely used for different types of applications. Material types of polysiloxane may include elastomers; gels, lubricants, foams, and adhesives. According to an example, the main backbone chain of polysiloxane may be very chemically stable and unreactive, while polysiloxane may include a functional group as a side chain that may be reactive. Different types of polysiloxane can be hydrophobic and have low moisture uptake. Different types of polysiloxane may have good electrical insulation characteristics. For example, the polysiloxane as the silicon-based compound may include a site including a hydrogen atom that is capable of reacting with the hydroxyl group. For example, the silicon-based compound may include a reactive site including a hydrogen atom that is capable of reacting with the hydroxyl group, and in this case, when an amount of silicon-based compound is applied for reactions with hydroxyl groups, it is possible that some of the hydrogen atoms respectively at the plurality of reactive sites may react with the hydroxyl groups, while some hydrogen atoms may remain unreacted.

For example, different types of polysiloxane may include a silicon atom forming a covalent bond with a hydrogen atom. For example, a type of polysiloxane may be an alkyl hydrogen silicon oil. For example, different types of polysiloxane in the silicon-based compound may have a chemical structure represented by the following Formulae 1:

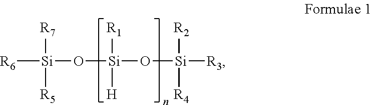

where R1 through R7 each independently represents a hydrogen atom, or alkyl which has 1 to 25 carbons, or the alkoxy group which has 1-10 carbons, and where n represents an integer greater than or equal to 1. For example, the silicon-based compound having the chemical structure represented by

Formulae 1 may include a plurality of hydrogen atoms that are capable of reacting with the hydroxyl group, and in this case, when an amount of the silicon-based compound is applied for reactions with hydroxyl groups, it is possible that all or some of the hydrogen atoms respectively at the plurality of reactive sites may react with the hydroxyl groups, while none or some hydrogen atoms may remain unreacted, depending on, for example, amounts of reactants, the density of the available hydroxyl group or the hydrogen group, or different kinetics between the silicon-based compound and a compound having a hydroxyl group.

For example, a type of polysiloxane compound may have a chemical structure represented by the following formulae 2:

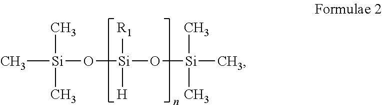

where, R1 represents a hydrogen atom, or alkyl which has 1 to 25 carbons, or the alkoxy group which has 1-10 carbons, and where n represents an integer greater than or equal to 1. For example, the silicon-based compound may be a derivative of polydimethylsiloxane where one of the methyl groups is replaced with a hydrogen atom.

For example, a type of polysiloxane may be polymethylhydrosiloxane having a chemical structure represented by the following formulae 3:

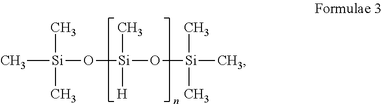

where n represents an integer greater than or equal to 1.

According to an example, the amount of the silicon-based compound, such as a siloxane, which is capable of replacing, removing or converting the hydroxyl group in the protective layer 330, may be based on the extent of surface energy, hydrophobicity/hydrophilicity, and/or other properties affected by the amount of the silicon-based compound.

According to an example, the amount of the silicon-based compound that is capable of replacing, removing or converting the hydroxyl group in the protective layer 330, for example, in combination with a urethane acrylate-based compound, may be based on the number of or the density of hydroxyl groups in the urethane acrylate-based compound and/or the number of or the density of hydroxyl groups in the silicon-based compound. According to an example, the amount of the silicon-based compound that is capable of replacing, removing or converting the hydroxyl group in the protective layer 330 may be based on the total amount of the protective layer itself, for example, to utilize a property of the silicon-base compound itself other than hydroxyl group-capping effect, such as a relatively hydrophobic property, or along with such a hydroxyl group-capping effect. For example, when an amount of the silicon-based compound having a hydrogen atom that is capable of reacting with the hydroxyl group is applied for reactions with hydroxyl groups, it is possible that all or some of the hydrogen atoms respectively at the plurality of reactive sites may react with the hydroxyl groups, while none or some hydrogen atoms may remain unreacted, depending on, for example, amounts of reactants, the density of the available hydroxyl group or different kinetics between the silicon-based compound and a compound having a hydroxyl group. In this case, the amount of silicon-based compound may be based on the properties of the silicon-based compound or according to the properties of the protective layer 330 that can be varied based on the amount of the silicon-based compound, with regards to or regardless of the density of the hydroxyl group or reaction kinetics between the hydrogen group of the silicon-based compound and the hydroxyl group.

For example, when the polymethylhydrosiloxane having a chemical structure represented by Formulae 3 is used, for example, in combination with a urethane acrylate-based compound having a hydroxyl group, the amount of the polymethylhydrosiloxane may be based on the number of or the density of hydroxyl groups in the urethane acrylate-based compound and/or the number of or the density of hydrogen groups in the polymethylhydrosiloxane. For example, when the polymethylhydrosiloxane having a chemical structure represented by Formulae 3 is used, for example, in combination with a urethane acrylate-based compound having a hydroxyl group, the amount of the polymethylhydrosiloxane may be mainly based on a factor other than the number of or the density of hydroxyl groups in the urethane acrylate-based compound and/or the number of or the density of hydrogen groups in the polymethylhydrosiloxane.

For example, the amount of the silicon-based compound that is capable of replacing, removing or converting the hydroxyl group in the protective layer 330 may influence the level of the surface energy of the surface of the protective layer, which is to be lowered to achieve at least some of the above-disclosed effects. Increasing the amount the silicone-based compound may decrease the hydrophilicity, increase hydrophobicity, and/or reduce the surface energy, and may further reduce or suppress the dot deletion effect and/or the toner filming effect, and/or to extend the operation life of the protective layer, such effects may be relatively reduced when available hydroxyl groups decreases and the amount of the silicon-based compound becomes more dominant with respect to the available hydroxyl groups while the increased amount of silicon-based compound may further decrease the surface energy when the silicon-based compound itself has relatively. Moreover, the increased amount of the silicon-based compound may reduce the surface potential excessively, which may reduce the printed image quality. For example, while an increased amount of the silicon-based compound may reduce the friction level by lowering the surface energy, an excess amount of the silicon-based compound may have an excessive effect on the surface properties, such as a surface coarseness or surface uneveness, a possible interference with electron transfer property due to its insulating effect, and/or excessive effect on surface properties, such as a surface evenness or surface roughness. On the other hand, including an insufficient amount of the silicone-based compound may not achieve sufficient effect of lowering surface energy, the hydroxyl group may not be effectively replaced, removed, or coverted, possibly due to insufficient kinetics.

According to an example, because the silicon-based compound, such as the polymethylhydrosiloxane, which is to replace, remove or convert the hydroxyl group, lowers the surface energy of the protective layer 330, decreases its hydrophilicity, and/or increases its hydrophobicity, the protective layer 330 with the hydroxyl group replaced, removed or capped by the silicon-based compound may repel the moisture more effectively, and therefore, suppress the effects of high moisture during the image forming process involving the photosensitive body 300, for example, in a high humidity environment. For example, the photosensitive body with the silicon-based compound replacing, removing or converting the hydroxyl group may further suppress the dot deletion effect or toner filming effect, for example, in a high humidity environment: Moreover, because the silicon-based compound according to an example may lower the surface energy, the silicon-based compound may exhibit a lubricating effect on contact with another surface. The lubricating may further extend the operating life or mechanical durability of the photosensitive body, as the lubricating effect may reduce the friction on contact with another surface. The silicon-based compound according to an example may also increase the elasticity of the protective layer 330. This elasticity may reduce erosion by friction.

According to an example, when the polymethylhydrosiloxane having a chemical structure represented by Formulae 3 is used, for example, in combination with a urethane acrylate-based compound formed from an acrylate oligomer having a molecular weight equal to or more than about 1000 g and equal to or less than about 1350, and/or an acrylate monomer, which include a hydroxyl functional group such as a urethane acrylate having a molecular weight of about 1350, the relative dot deletion effect, compared to the protective layer not including the polymethylhydrosiloxane, may start to exhibit decreased hydrophilicity when the weight ratio is equal to or more than about 0.067 of the polymethylhydrosiloxane per 100 of the acrylate oligomer (e.g., about 0.67 milligram of polymethylhydrosiloxane per 1 gram of the acrylate oligomer). For example, when the weight ratio is equal to or more than about 3.3 of the polymethylhydrosiloxane per 100 of the acrylate oligomer (e.g., about 33 milligram of the polymethylhydrosiloxane per 1 gram of the acrylate oligomer), under a given condition, the relative dot deletion effect did not occur while the protective layer not including the polymethylhydrosiloxane still exhibited a detectable dot deletion effect. Accordingly, when the polymethylhydrosiloxane having a chemical structure represented by Formulae 3 is used, for example, in combination with a urethane acrylate-based compound formed from an acrylate oligomer and/or an acrylate monomer and including a hydroxyl functional group, the weight ratio between the weight of the polymethylhydrosiloxane and the weight of the acrylate oligomer may be equal to or more than about 0.07 of the polymethylhydrosiloxane per 100 of the acrylate oligomer (equal to or more than about 0.07:100), for example, equal to or more than about 3.3 of the polymethylhydrosiloxane per 100 of the acrylate oligomer (equal to or more than about 3.3:104 to decrease the hydrophilicity of the surface to decrease the likelihood of the dot deletion effect occurences.

The degree of surface energy, hydrophobicity, and/or hydrophilicity on the surface of the protective layer 330 may be represented by the contact angle of a liquid on the surface, According to an example, the surface of the protective layer 330 may exhibit more than about 20° of water contact angle, or more than about 16° of glycol contact angle, or more than about 84 mN/m of surface energy.

According to an example, the amount of the polymethylhydrosiloxane may be determined based on factors affecting properties of the protective layer 330.

For example, when the polymethylhydrosiloxane having a chemical structure represented by Formulae 3 is used, for example, in combination with a urethane acrylate-based compound formed from an acrylate oligomer having a molecular weight equal to or more than about 1000 g and equal to or less than about 1350 and/or an acrylate monomer, which include a hydroxyl functional group such as a urethane acrylate having a molecular weight of about 1350, the weight ratio between the weight of the polymethylhydrosiloxane and the weight of the acrylate oligomer may be less than about 1.67 of the polymethylhydrosiloxane per 1 of the acrylate oligomer (less than about 1.67:1). When the weight ratio is not less than about 1.67 of the polymethylhydrosiloxane per 1 of the acrylate oligomer, e.g., when the weight ratio is in about 1.67 of the polymethylhydrosiloxane per 1 of the acrylate oligomer or more, the photosensitivity of the photosensitive body may be degraded, possibly due to the insulation effect of the polymethylhydrosiloxane in the ratio of 1.67:1 or more. For example, a surface region of the photosensitive body that is to be discharged to a charge level by light may still carry excess charge above the charge level even after being discharged by the light exposure, which may degrade the formed image quality by toner, for example, by adding additional shadings to the white balance.

According to an example, when the polymethylhydrosiloxane having a chemical structure represented by Formulae 3 is used, for example, in combination with a urethane acrylate-based compound formed from an acrylate oligomer having a molecular weight equal to or more than about 1000 g and equal to or less than about 1350 and/or an acrylate monomer, which include a hydroxyl functional group such as a urethane acrylate having a molecular weight of about 1350, the weight ratio between the weight of the polymethylhydrosiloxane and the weight of the acrylate oligomer may be less than or equal to about 1.33 of the polymethylhydrosiloxane per 1 of the acrylate oligomer (1.33:1). When the weight ratio is more than about 1.33 of the polymethylhydrosiloxane per 1 of the acrylate oligomer, the surface tension of the uncured protective layer 330 during the curing may become more inconsistent, and as a result, surface roughness may increase or a surface evenness may decrease when the uncured protective layer 330. The surface defect rate may also increase due to the inconsistent surface tension during the curing.

For example, there may be a non-linear based shift in the degree of the photo-discharge insulation effect with respect to the variation in the amount of the polymethylhydrosiloxane. For example, when the weight ratio is more than about 0.67 of the polymethylhydrosiloxane per 1 of the acrylate oligomer or more (more than about 0.67:1), the photosensitivity of the photosensitive body may start to decrease more rapidly, for example, in a non-linear manner, indicating a more rapid increase in the photo-discharge insulation effect. Accordingly, when the polymethylhydrosiloxane having a chemical structure represented by Formulae 3 is used, for example, in combination with a urethane acrylate-based compound formed from an acrylate oligomer and/or an acrylate monomer and including a hydroxyl functional group, the weight ratio between the weight of the polymethylhydrosiloxane and the weight of the acrylate oligomer may be equal to or less than about 0.67 of the polymethylhydrosiloxane per 1 of the acrylate oligomer (less than about 0.67:1).

For example, when the polymethylhydrosiloxane having a chemical structure represented by Formulae 3 is used, the relative dot deletion effect, compared to the protective layer without including the polymethylhydrosiloxane, may start to reduce in a given condition when the weight percent (wt. %) of the polymethylhydrosiloxane with respect to the weight of the protective layer 330 material formed may be about 0.03 wt. %. For example, when the weight percent (wt. %) of the polymethylhydrosiloxane with respect to the weight of the protective layer 330 material formed was about 1:6 wt. %, under a given condition, the relative dot deletion effect did not occur when the protective layer not including the polymethylhydrosiloxane started exhibiting a detectable dot deletion effect. Accordingly, when the polymethylhydrosiloxane having a chemical structure represented by Formulae 3 is used, the weight percent (wt. %) of the polymethylhydrosiloxane with respect to the weight of the protective layer 330 material formed may be more than about 0.03 wt. %, for example, more than 1.6 wt. %.

For example, when the polymethylhydrosiloxane having a chemical structure represented by Formulae 3 is used, the weight percent (wt. %) of the polymethylhydrosiloxane with respect to the weight of the protective layer 330 material formed may be less than about 44.9 wt. %. When the weight percent is equal to or more than about 44.9 wt. %, of the polymethylhydrosiloxane per 1 of the acrylate oligomer, the photosensitivity of the photosensitive body may be degraded, possibly due to the insulation effect of the polymethylhydrosiloxane.

For example, when the polymethylhydrosiloxane having a chemical structure represented by Formulae 3 is used, the weight percent (wt. %) of the polymethylhydrosiloxane may be equal to or less than about 39 wt. % with respect to the weight of the protective layer 330 material formed. When the weight percent (wt. %) of the polymethylhydrosiloxane is more than than about 39 wt. % with respect to the weight of the protective layer 330 material formed, the surface tension of the uncured protective layer 330 during the curing may become more inconsistent, and as a result, surface roughness may increase or surface evenness may decrease when the uncured protective layer 330. The surface defect rate may also increase due to the inconsistent surface tension during the curing.

For example, there may be a non-linear based shift in the degree of the photo-discharge insulation effect with respect to the variation in the amount of the polymethylhydrosiloxane. For example, when the weight percent (wt. %) of the polymethylhydrosiloxane is more than about 24.6 wt. % with respect to the weight of the protective layer 330 material formed, the photosensitivity of the photosensitive body may start to decrease more rapidly, for example, in a non-linear manner, indicating a more rapid increase in the photo-discharge insulation effect. Accordingly, when the polymethylhydrosiloxane having a chemical structure represented by Formulae 3 is used, the weight percent (wt. %) of the polymethylhydrosiloxane may be equal to or less than about 24.6 wt. % with respect to the weight of the protective layer 330 material formed.

According to an example, the surface characteristics of the protective layer 330 formed after including polymethylhydrosiloxane may further be modified by another compound. For example, the protective layer 330 may further include perfluoropolyether acrylate or modified perfluoropolyether acrylate. For example, the modified perfluoropolyether acrylate may be present in a state of being bonded in the protective layer 330, by being crosslinked with the urethane oligomer acrylate.

According to an example, the solvent used in the protective layer composition solution may be used alone, or in a mixture of two or more. According to an example, a propanol solvent for electron transfer material or the electron transfer solution including the electron transfer material, and a methanol solvent may be used for the photo-curable solution including both the photo-curable material and the silicon-based water-repellent such as polymethylhydrosiloxane. To increase the solubility of the silicon-based water-repellent, a mixture of solvents may be used. For example, a first solvent that is relatively polar and a second solvent that is relatively non-polar may be used as the solvent. For example, methanol alone may be used, or a mixture of methanol as the relatively polar solvent and hexane as the relatively non-polar solvent may be used as the solvent for both the photo-curable material and the silicon-based water-repellent such as polymethylhydrosiloxane.

The photosensitive body 300 having the protective layer 330 according to an example, based on the disclosure, may reduce the influence of moisture, and have improved durability of the mechanical properties such as resistance to dot-deletion effect of toner filming effect, crushing resistance, scratch resistance and abrasion resistance. Accordingly, the photosensitive body 300 may stably provide a higher quality image over an extended operating life.

Accordingly, according to an example, a photosensitive body 300 for an image forming apparatus 1000 may include a photosensitive layer including a protective layer 330 formed on the photosensitive layer 320, where the protective layer 330 may include a urethane oligomer-based compound including urethane oligomer acrylates and a polysiloxane including a silicon atom (Si) covalently bonded to a first side chain including an oxygen atom (O) covalently bonded to the urethane oligomer-based compound.

According to an example, the silicon atom (Si) may be covalently bonded to a second side chain including an alkyl group or an alkoxyl group.

According to an example, the silicon atom (Si) may be covalently bonded to a second side chain including an alkyl group having 1 to 25 carbon atoms or an alkoxyl group including 1 to 10 carbon atoms.

According to an example, the urethane oligomer-based compound may include acrylate monomers crosslinked with the urethane oligomer acrylates.

According to an example, the polysiloxane may a polymethylsiloxane including the silicon atom (Si) covalently bonded to the first side chain including the oxygen atom (O) covalently bonded to the urethane oligomer-based compound and a second side chain being a methyl group.

According to an example, an amount of the polymethylsiloxane may be more than about 0.03 parts by weight and less than 1.67 parts by weight per 1 part of the urethane oligomer-based compound by weight.

According to an example, the amount of the polymethylsiloxane is equal to or less than about 1.33 parts by weight per 1 part of the urethane oligomer-based compound by weight.

According to an example, the amount of the polymethylsiloxane is equal to or less than about 0.67 parts by weight per 1 part of the urethane oligomer-based compound by weight.

According to an example, a cartridge 500 couplable to an image forming apparatus may include a photosensitive body 300 including a photosensitive layer 320 and a protective layer 330 formed on the photosensitive layer 320. The protective layer may include a urethane oligomer-based compound including urethane oligomer acrylates and a polysiloxane including a silicon atom (Si) having a first side chain including an oxygen atom (O) covalently bonded to the urethane oligomer-based compound.

According to an example, the silicon atom (Si) may be covalently bonded to a second side chain including an alkyl group or an alkoxyl group.

According to an example, the silicon atom (Si) may be covalently bonded to a second side chain including an alkyl group having 1 to 25 carbon atoms or an alkoxyl group including 1 to 10 carbon atoms.

According to an example, the polysiloxane may be a polymethylsiloxane including the silicon atom (Si) be covalently bonded to the first side chain and a second side chain being a methyl group.

According to an example, an amount of the polymethylsiloxane may be more than about 0.03 parts by weight and less than 1.67 parts by weight per 1 part of the urethane oligomer-based compound by weight.

According to an example, the amount of the polymethylsiloxane may be equal to or less than about 1.33 parts by weight per 1 part of the urethane oligomer-based compound by weight.

According to an example, the amount of the polymethylsiloxane is equal to or less than about 0.67 parts by weight per 1 part of the urethane oligomer-based compound by weight.

According to an example, a photosensitive body 300 may include a photosensitive layer 320 and a protective layer 330 formed on the photosensitive layer 320, where the protective layer 330 may include a urethane oligomer-based compound including urethane oligomer acrylates and a polysiloxane including a silicon atom (Si) covalently bonded to a first side chain including an oxygen atom (O) covalently bonded to the urethane oligomer-based compound, the polysiloxane having a chemical structure represented by the following Formulae 1.

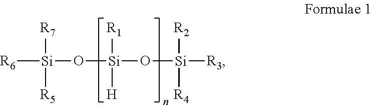

where R1 through R7 each independently represents a hydrogen atom, or an alkyl group which has 1 to 25 carbons, or an alkoxy group which has 1-10 carbons, where n represents an integer greater than or equal to 1, and where each respective H independently represents a hydrogen atom or the oxygen atom (O) covalently bonded to the urethane oligomer-based compound.

According to an example, the urethane oligomer-based compound may include acrylate monomers crosslinked with the urethane oligomer acrylates.

According to an example, the R1 through the R7 may each represents a methyl group.

According to an example, an amount of the polysiloxane may be more than about 0.03 parts by weight and less than 1.67 parts by weight per 1 part of the urethane oligomer-based compound by weight.

According to an example, the amount of the polysiloxane may be equal to or less than about 1.33 parts by weight per 1 part of the urethane oligomer-based compound by weight.

According to an example, the amount of the polysiloxane may be equal to or less than about 0.67 parts by weight per 1 part of the urethane oligomer-based compound by weight.

According to an example, a photosensitive body 300 may include a photosensitive layer 320 and a protective layer 330 formed on the photosensitive layer 320, where the protective layer 330 may include a urethane oligomer-based compound including urethane oligomer acrylates and a polysiloxane having a chemical structure represented by the following Formulae 1:

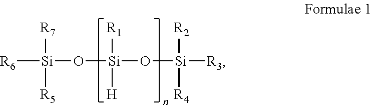

where R1 through R7 each independently represents a hydrogen atom, or an alkyl group which has 1 to 25 carbons, or an alkoxy group which has 1-10 carbons, where n represents an integer greater than or equal to 1, and where H represents a hydrogen atom.

According to an example, the R1 through the R7 each may represent a methyl group.

According to an example, an amount of the polysiloxane may be more than about 0.03 parts by weight and less than 1.67 parts by weight per 1 part of the urethane oligomer-based compound by weight.

According to an example, the amount of the polysiloxane may be equal to or less than about 1.33 parts by weight per 1 part of the urethane oligomer-based compound by weight.

According to an example, the amount of the polysiloxane may be equal to or less than about 0.67 parts by weight per 1 part of the urethane oligomer-based compound by weight.

According to an example, a cartridge couplable to an image forming apparatus 1000 may include a photosensitive body 300, which may include a photosensitive layer 320 and a protective layer 330 formed on the photosensitive layer 320, where the protective layer 330 may include a urethane oligomer-based compound including urethane oligomer acrylates and a polysiloxane including a silicon atom (Si) covalently bonded to a first side chain including an oxygen atom (O) covalently bonded to the urethane oligomer-based compound, the polysiloxane having a chemical structure represented by the following Formulae 1:

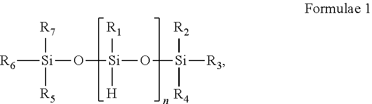

where R1 through R7 each independently represents a hydrogen atom, or an alkyl group which has 1 to 25 carbons, or an alkoxy group which has 1-10 carbons, where n represents an integer greater than or equal to 1, and where each respective H independently represents a hydrogen atom or the oxygen atom (O) covalently bonded to the urethane oligomer-based compound.

According to an example, the R1 through the R7 each may represents a methyl group, and an amount of the polysiloxane may be more than about 0.03 parts by weight and less than 1.67 parts by weight per 1 part of the urethane oligomer-based compound by weight.

According to an example, the amount of the polysiloxane may be equal to or less than about 1.33 parts by weight per 1 part of the urethane oligomer-based compound by weight.

According to an example, the amount of the polysiloxane may be equal to or less than about 0.67 parts by weight per 1 part of the urethane oligomer-based compound by weight.

The followings are experimental examples of the disclosure.

### Example 1

According to an example, the protective layer 330 of Example 1 for the photosensitive body 300 was formed by the following method. A first mixture solution, as the electron transfer material solution including conductive material as the electron transfer material, was prepared by adding about 15 parts by weight of electron transfer material, about 6 parts by weight of a polymer dispersant, and about 0.5 parts by weight of a synergist, to about 78.5 parts by weight of propanol as a solvent. For example, the electron transfer material used in Example 1 was titanium dioxide as core particles coated with antimony-doped tin oxide. For example, the material used in Example 1 was ET-500W manufactured by ISK. For the polymer dispersant, for example, SOLSPERSE 20000 made by BASF was used. For the synergist, for example, SOLSPERSE 22000 made by BASF was used. To facilitate mixing, about 200 parts by weight of 0.8 mmϕ zirconia beads can be added, which can be filtered out and removed from the mixture later. The electron transfer material solution including the above-listed materials was then mixed by a paint shaker for about 3 hours, and then filtered by sus mesh, for example, to filter the zirconia beads from the electron transfer material solution and/or particles exceeding a threshold. The viscosity and the average particle size of the electron transfer material solution filtered by the sus mesh were measured using, respectively, a viscosity meter (BROOKFIELD DV2T) and an average particle size meter (OTSUKA ELS-Z). The measured viscosity was 4.81 cP, and the measured average particle size was 103 nm. These viscosity and average particle size are, for example, for more stably maintaining dispersions and distributions of particles in suspension prior to the coating.

According to an example, a second mixture solution as the photo-curable solution was prepared using about 9.5 parts by weight of a urethane oligomer acrylate and/or an acrylate monomer, which can be selected and adjusted to control the properties of the cured urethane acrylate, about 6 parts by weight of a photoinitiator, about 0.5 parts by weight of a leveling agent, and about 0.5 parts by weight of silicon-based material dissolved in about 78.5 parts by weight of methanol and/or hexane. Accordingly, the weight percent (wt. %) of the silicon-based material was 0.5 wt. % in the second mixture solution as the photo-curable solution. For the urethane oligomer acrylate, aliphatic urethane multi-acrylate having 10 functional groups and having a molecular weight of 1350, such as GU7400Z manufactured by QUALIPOLY was used. For the acrylate monomer, dipentaerythritol hexaacrylate DPHA having a molecular weight of 578, such as GM66GOL manufactured by QUALIPOLY, was used. For the leveling agent, BYK-310 manufactured by BYK was used. For the silicon-based material, methyl hydrogen silicone fluid, such as polymethylhydrosiloxane having a chemical structure represented by the following formulae 3 has been used:

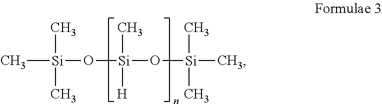

where n represents an integer greater than or equal to 1.
For example, polymethylhydrosiloxane having the viscosity of about 25 mm²/s at 25° C., the specific gravity of about 1 at 25° C., and/or the refractive index (n_{D}²⁵) of about 1.396 was used. For example, TSF 484 manufactured by MOMENTIVE was used. The photo-curable solution including the above-listed materials was mixed by a roll-mixer (e.g., a roll-mixer made by IKA) for about 24 hours before use.

According to an example, the protective layer solution to form the protective layer 330 was prepared by mixing 3 parts by weight of the first mixture solution as the electron transfer material solution and 7 parts by weight of the second mixture solution as the photo-curable solution.

This composition was coated on a photosensitive body by a ring coater. After the coating, the solvents used for the composition may be removed, for example, by evaporation. Accordingly, the amount by weight of the polymethylhydrosiloxane in the formed protective layer 330 according to Example 1 was about 1.6 wt. % with respect to the weight of the composition forming the protective layer 330. The amount of the polymethylsiloxane was about 3 parts by weight per 100 part of the urethane oligomer-based compound by weight in the composition forming the protective layer 330.

### Example 2

According to an example, the protective layer 330 of Example 2 for the photosensitive body 300 was prepared in the same manner as in Example 1, except that in the second mixture solution as the photo-curable solution, 5 parts by weight of the silicon-based material, methyl hydrogen silicone fluid, such as polymethylhydrosiloxane having a chemical structure represented by the following formulae 3, such as polymethylhydrosiloxane having the viscosity of about 25 mm²/s at 25° C., the specific gravity of about 1 at 25° C., and/or the refractive index (n_{D}²⁵) of about 1.396 was used. For example, TSF 484 manufactured by MOMENTIVE was used. Accordingly, the weight percent (wt. %) of the silicon-based material was 5 wt. % in the second mixture solution as the photo-curable solution. Accordingly, the amount by weight of the polymethylhydrosiloxane in the formed protective layer 330 according to Example 2 was about 14 wt. % with respect to the weight of the composition forming the protective layer 330. The amount of the polymethylsiloxane was about 0.33 parts by weight per 1 part of the urethane oligomer-based compound by weight in the composition forming the protective layer 330.

### Example 3

According to an example, the protective layer 330 of Example 3 for the photosensitive body 300 was prepared in the same manner as in Example 1, except that in the second mixture solution as the photo-curable solution, 10 parts by weight of the silicon-based material, methyl hydrogen silicone fluid, such as polymethylhydrosiloxane having a chemical structure represented by the following formulae 3, such as polymethylhydrosiloxane having the viscosity of about 25 mm²/s at 25° C., the specific gravity of about 1 at 25° C., and/or the refractive index (n_{D}²⁵) of about 1,396 was used. For example, TSF 484 manufactured by MOMENTIVE was used. Accordingly, the weight percent (wt. %) of the silicon-based material was 10 wt. % in the second mixture solution as the photo-curable solution. Accordingly, the amount by weight of the polymethylhydrosiloxane in the formed protective layer 330 according to Example 3 was about 24.6 wt. % with respect to the weight of the composition forming the protective layer 330. The amount of the polymethylsiloxane was about 0.67 parts by weight per 1 part of the urethane oligomer-based compound by weight in the composition forming the protective layer 330.

### Example 4

According to an example, the protective layer 330 of Example 4 for the photosensitive body 300 was prepared in the same manner as in Example 1, except that in the second mixture solution as the photo-curable solution, 15 parts by weight of the silicon-based material, methyl hydrogen silicone fluid, such as polymethylhydrosiloxane having a chemical structure represented by the following formulae 3, such as polymethylhydrosiloxane having the viscosity of about 25 mm²/s at 25° C., the specific gravity of about 1 at 25° C., and/or the refractive index (n_{D}²⁵) of about 1.396 was used. For example, TSF 484 manufactured by MOMENTIVE was used. Accordingly, the weight percent (wt. %) of the silicon-based material was 15 wt. % in the second mixture solution as the photo-curable solution. Accordingly, the amount by weight of the polymethylhydrosiloxane in the formed protective layer 330 according to Example 4 was about 33 wt. % with respect to the weight of the composition forming the protective layer 330. The amount of the polymethylsiloxane was about 1 part by weight per 1 part of the urethane oligomer-based compound by weight in the composition forming the protective layer 330.

### Example 5

According to an example, the protective layer 330 of Example 2 for the photosensitive body 300 was prepared in the same manner as in Example 1, except that in the second mixture solution as the photo-curable solution, 20 parts by weight of the silicon-based material, methyl hydrogen silicone fluid, such as polymethylhydrosiloxane having a chemical structure represented by the following formulae 3, such as polymethylhydrosiloxane having the viscosity of about 25 mm²/s at 25° C., the specific gravity of about 1 at 25° C., and/or the refractive index (n_{D}²⁵) of about 1.396 was used. For example, TSF 484 manufactured by MOMENTIVE was used. Accordingly, the weight percent (wt. %) of the silicon-based material was 20 wt. % in the second mixture solution as the photo-curable solution. Accordingly, the amount by weight of the polymethylhydrosiloxane in the formed protective layer 330 according to Example 5 was about 39 wt. % with respect to the weight of the composition forming the protective layer 330. The amount of the polymethylsiloxane was about 1.3 part by weight per 1 part of the urethane oligomer-based compound by weight in the composition forming the protective layer 330.

### Comparative Example 1

According to an example, the protective layer 330 of Comparative Example 1 for the photosensitive body 300 was prepared in the same manner as in Example 1, except that in the second mixture solution as the photo-curable solution, no amount of the silicon-based material was included. Accordingly, the protective layer 330 according to Comparative Example 1 did not contain the silicon-based material such as polymethylhydrosiloxane.

### Comparative Example 2

According to an example, the protective layer 330 of Comparative Example 2 for the photosensitive body 300 was prepared in the same manner as in Example 1, except that in the second mixture solution as the photo-curable solution, 0.005 parts by weight of the silicon-based material, methyl hydrogen silicone fluid, such as polymethylhydrosiloxane having a chemical structure represented by the following formulae 3, such as polymethylhydrosiloxane having the viscosity of about 25 mm²/s at 25° C., the specific gravity of about 1 at 25° C., and/or the refractive index (n_{D}²⁵) of about 1.396 was used. For example, TSF 484 manufactured by MOMENTIVE was used. Accordingly, the weight percent (wt. %) of the silicon-based material was 0.005 wt. % in the second mixture solution as the photo-curable solution. Accordingly, the amount by weight of the polymethylhydrosiloxane in the formed protective layer 330 according to Comparative Example 3 was about 0.016 wt. % with respect to the weight of the composition forming the protective layer 330. The amount of the polymethylsiloxane was about 0.03 part by weight per 100 part of the urethane oligomer-based compound by weight in the composition forming the protective layer 330.

### Comparative Example 3

According to an example, the protective layer 330 of Comparative Example 3 for the photosensitive body 300 was prepared in the same manner as in Example 1, except that in the second mixture solution as the photo-curable solution, 0.01 parts by weight of the silicon-based material, methyl hydrogen silicone fluid, such as polymethylhydrosiloxane having a chemical structure represented by the following formulae 3, such as polymethylhydrosiloxane having the viscosity of about 25 mm²/s at 25° C., the specific gravity of about 1 at 25° C., and/or the refractive index (n_{D}²⁵) of about 1.396 was used. For example, TSF 484 manufactured by MOMENTIVE was used. Accordingly, the weight percent (wt. %) of the silicon-based material was 0.01 wt. % in the second mixture solution as the photo-curable solution. Accordingly, the amount by weight of the polymethylhydrosiloxane in the formed protective layer 330 according to Comparative Example 3 was about 0.033 wt. % with respect to the weight of the composition forming the protective layer 330. The amount of the polymethylsiloxane was about 0.07 part by weight per 100 part of the urethane oligomer-based compound by weight in the composition forming the protective layer 330.

### Comparative Example 4

According to an example, the protective layer 330 of Comparative Example 4 for the photosensitive body 300 was prepared in the same manner as in Example 1, except that in the second mixture solution as the photo-curable solution, 25 parts by weight of the silicon-based material, methyl hydrogen silicone fluid, such as polymethylhydrosiloxane having a chemical structure represented by the following formulae 3, such as polymethylhydrosiloxane having the viscosity of about 25 mm²/s at 25° C., the specific gravity of about 1 at 25° C., and/or the refractive index (n_{D}²⁵) of about 1.396 was used. For example, TSF 484 manufactured by MOMENTIVE was used. Accordingly, the weight percent (wt. %) of the silicon-based material was 25 wt. % in the second mixture solution as the photo-curable solution. Accordingly, the amount by weight of the polymethylhydrosiloxane in the formed protective layer 330 according to Comparative Example 3 was about 44.87 wt. % with respect to the weight of the composition forming the protective layer 330. The amount of the polymethylsiloxane was about 1.67 part by weight per 1 part of the urethane oligomer-based compound by weight in the composition forming the protective layer 330.

The above Examples and Comparative Examples are summarized in the following Table 1:

TABLE 1

| | Comparative | Example | Example | Example | Example | Comparative |
|---|---|---|---|---|---|---|
| | Example 1 | 2 | 3 | 4 | 5 | Example 4 |
| Water contact | 20 | 28 | 34 | 37 | 43 | 62 |
| angle(°) | | | | | | |
| Glycol contact | 16 | 24 | 29 | 34 | 38 | 57 |
| angle(°) | | | | | | |
| Surface | 83.99 | 78.29 | 72.55 | 71.33 | 63.99 | 44.52 |
| Energy | | | | | | |
| (mN/m) | | | | | | |
| E ½ | 0.01216 | 0.1406 | 0.13 | 0.1552 | 0.1535 | 0.20009 |
| (μJ/cm²) | | | | | | |
| E200 | 0.1694 | 0.2082 | 0.1984 | — | — | — |
| (μJ/cm²) | | | | | | |
| E100 | — | — | — | — | — | — |
| (μJ/cm²) | | | | | | |
| V_{L} (V) | −134 | −148 | −159 | −207 | −209 | −243 |
| ΔV_{L} (V) | 0 | −14 | −25 | −73 | −75 | −109 |
| Vᵣ (V) | −57 | −67 | −79 | −120 | −121 | −158 |

In Table 1, E ½ refers to the intensity of light energy to discharge the surface potential of the photosensitive body value by about 50% after the photosensitive body was charged by the charger (unit: μJ/cm²), E200 refers to the intensity of light energy to discharge the surface potential of the photosensitive body value to −200 V after the photosensitive body was charged by the charger (unit: μJ/cm²). E100 refers to the intensity of light energy to discharge the surface potential of the photosensitive body value to −100 V after the photosensitive body was charged by the charger (unit: μJ/cm²). The notation “-” means the applied maximum light intensity was not sufficient to discharge the surface of the photosensitive body to the indicated level, V_{L} refers to a residual surface potential of the photosensitive body 300 after being exposed to light having an energy level of 0.5238 μJ/cm²(unit: V). ΔV_{L} refers to a residual surface potential difference between the V_{L} value of a sample and the V_{L} value of Comparative Example 1. Vr refers to a residual surface potential value of the photosensitive body 300 after the surface was discharged by the light to reset the photosensitive body surface potential.

In Table 1, as the amount of the polymethylhydrosiloxane increases from 0 parts (Comparative Example 1) to 1.67 parts (Comparative Example 4) by weight per 1 part of the urethane oligomer-based compound by weight, the surface energy was decreased and the water contact angle was increased, indicating the relatively decreased hydrophilicity and relatively increased hydrophobicity. However, the surface potential difference between the sample and Comparative Example 1, after light exposure at 0.5238 μJ/cm², was increased as the amount of the polymethylhydrosiloxane was increased from 0 parts (Comparative Example 1) to 1.67 parts (Comparative Example 4) by weight per 1 part of the urethane oligomer-based compound by weight. E1/2, E200, and Vr also indicated a trend of increase as the amount of polymethylhydrosiloxane was increased. This indicates the decrease in the photosensitivity of the photosensitive body 300, as the residual surface potential is still maintained higher after light exposure when the amount of the polymethylhydrosiloxane increased, possibly due to its insulating effect of polymethylhydrosiloxane. A higher residual surface potential after light exposure generally indicates the surface is relatively less photosensitive, as the surface potential is not being discharged by light exposure as readily as Comparative Example 1, which may affect the contrast of the printed image and degrade the image quality. In particular, the residual surface potential difference ΔV_{L} between a sample and Comparative Example 1 that is higher than −100 V is usually not an acceptable discharge level and photosensitivity for image quality. Table 1 indicates that the Comparative Example 4 having 1.67 parts (Comparative Example 4) by weight per 1 part of the urethane oligomer-based compound by weight will result in the residual surface potential differential that is higher than −100 V. Hence, based on the experimental results, the amount of the polymethyhydrogensiloxane is to be included less than 1.67 parts by weight per 1 part of the urethane oligomer-based compound by weight, to have the surface potential difference ΔV_{L} less than −100 V. For example, when the amount of the polymethyhydrogensiloxane was about 1.33 parts by weight per 1 part of the urethane oligomer-based compound by weight, the surface potential difference ΔV_{L} was less than −100 V.

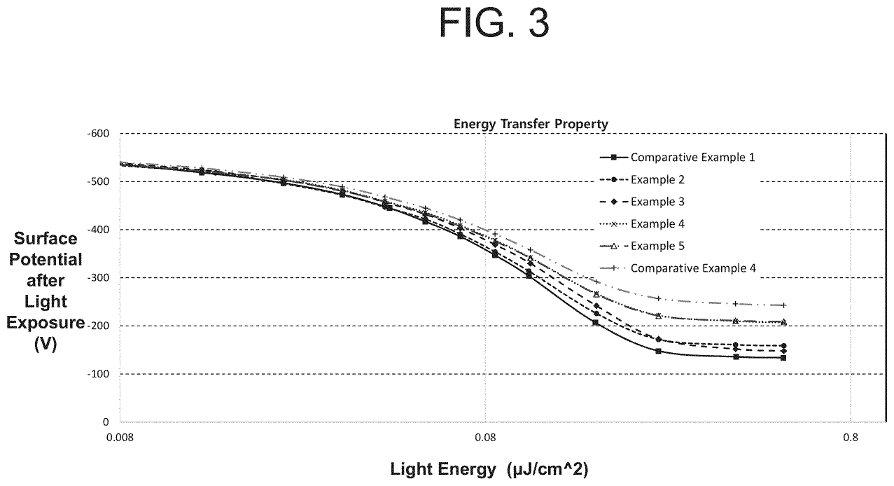

Moreover, as indicated Table 1 and FIG. 3, the degree of the surface potential difference ΔV_{L} unexpectedly increases non-linearly by a higher degree when the amount of the amount of the polymethyhydrogensiloxane is increased from about 0.67 part to about 1.33 parts by weight per 1 part of the urethane oligomer-based compound by weight. When the amount of the polymethyhydrogensiloxane is less than about 0.67 parts by weight per 1 part of the urethane oligomer-based compound by weight, the residual surface potential differential is maintained at a level closer to control example not including the polymethyhydrogensiloxane (Comparative Example 1). Accordingly, to maintain the surface potential differential relatively closer to the control level of Comparative Example 1, the amount equal to or less than about 0.67 by weight per 1 part of the urethane oligomer-based compound by weight has shown to be critical by the experimental results.

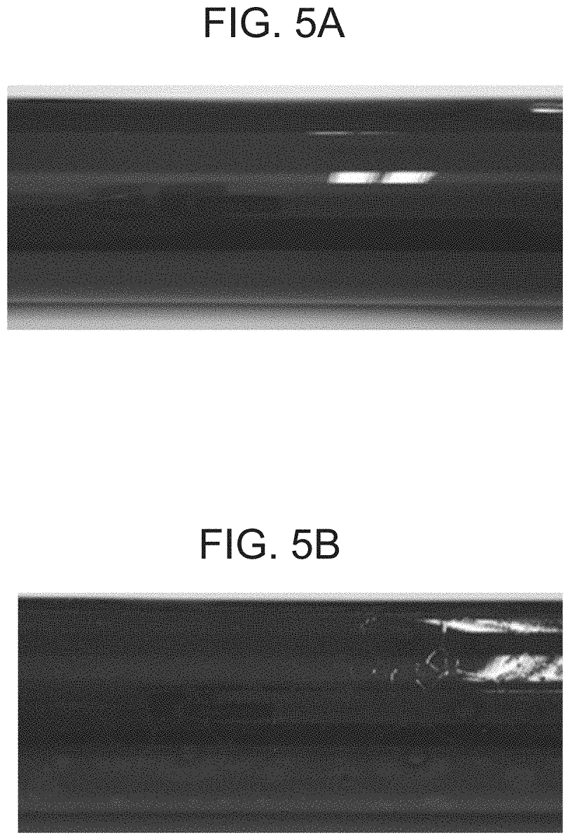

Moreover, as the amount of the polymethyhydrogensiloxane increase, the surface potential of the protective layer 330 during the curing may become more inconsistent over the surface, possibly due to the different reaction rates of photocuring and the hydroxyl group conversion, and/or possibly due to the relative viscosity difference between the polymethyhydrogensiloxane and other materials in the protective layer 330. As a result, as the amount of the polymethyhydrogensiloxane increases, the cured surface of the photosensitive body may have increased unevenness, roughness, or surface consistency. FIG. 5A represent a surface of the protective layer 330 of Example 1, which indicates that, when the amount of the polymethyhydrogensiloxane is 3.3 parts by weight per 100 part of the urethane oligomer-based compound by weight, the surface characteristics indicate a relatively even surface having a less number of surface defects. It was observed that the surface characteristics such as a relative evenness of the protective layer surface quality were acceptable until when the amount of the polymethyhydrogensiloxane was more than about 1.33 parts and less than 1.67 parts by weight per 1 part of the urethane oligomer-based compound by weight. However, as shown in FIG. 5B, the surface started showing a visible unevenness or roughness or inconsistency that can be considered as surface defects, when the amount of the polymethyhydrogensiloxane reached about 1.67 parts by weight per 1 part of the urethane oligomer-based compound by weight. Accordingly, the experimental results also indicated the unexpected criticality of the amount of the polymethyhydrogensiloxane being less than 1.67, for example, being equal to or more than about 1.33 parts, in terms of controlling or maintaining acceptable surface characteristics of the protective layer 330 according to an example.

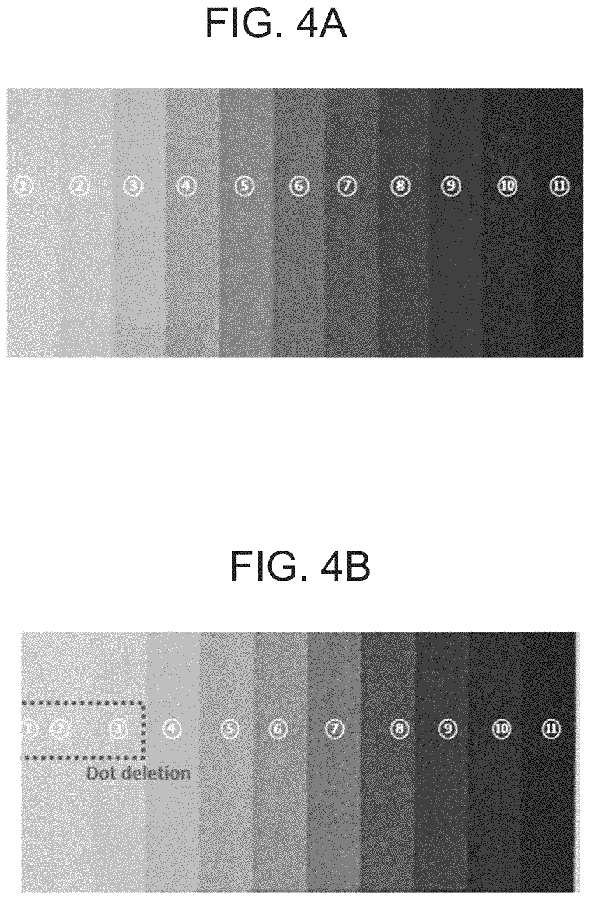

Experimental results also indicated that, when the amount of the polymethyhydrogensiloxane was equal to or more than about 0.033 parts by weight per 100 parts of the urethane oligomer-based compound by weight (Comparative example 2), the water-repellent effect, humidity resistance and surface hydrophobicity did not increase effectively, not effectively suppressing the dot deletion effect as shown in FIG. 4B. However, when the amount of the polymethyhydrogensiloxane was about more than 0.067 parts by weight per 100 parts of the urethane oligomer-based compound by weight (Comparative example 3), the water-repellent effect, humidity resistance and surface hydrophobicity started to increase and the dot deletion effect started to show improvement. When the amount of the polymethyhydrogensiloxane was about more than 3.3 parts by weight per 100 parts of the urethane oligomer-based compound by weight (Example 1), as shown in FIG. 4A, the water-repellent effect, humidity resistance and surface hydrophobicity unexpectedly increased substantially, effectively suppressing the dot deletion effect, which shows the criticality of polymethyhydrogensiloxane was about more than 3.3 parts by weight per 100 parts of the urethane oligomer-based compound by weight.

While various examples have been described with reference to the drawings, it will be understood that various changes in form and details may be made therein without departing from the spirit and scope as defined by the following claims.

What is claimed is:

1. A photosensitive body for an image forming apparatus and including a photosensitive layer, comprising:
a protective layer formed on the photosensitive layer, the protective layer including
a urethane oligomer-based compound including urethane oligomer acrylates, and
a polysiloxane including a silicon atom (Si) covalently bonded to a first side chain including an oxygen atom (O) covalently bonded to the urethane oligomer-based compound, the polysiloxane having a chemical structure represented by the following Formulae 1: 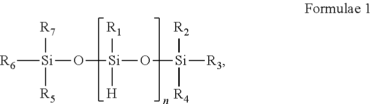
where R1 through R7 each independently represents a hydrogen atom, or an alkyl group which has 1 to 25 carbons, or an alkoxy group which has 1-10 carbons, where n represents an integer greater than or equal to 1, and where each respective H independently represents a hydrogen atom or the oxygen atom (O) covalently bonded to the urethane oligomer-based compound.

2. The photosensitive body according to claim 1, wherein the urethane oligomer-based compound includes acrylate monomers crosslinked with the urethane oligomer acrylates.

3. The photosensitive body according to claim 1, wherein the R1 through the R7 each represents a methyl group.

4. The photosensitive body according to claim 3, wherein
an amount of the polysiloxane is more than about 0.03 parts by weight and less than 1.67 parts by weight per 1 part of the urethane oligomer-based compound by weight.

5. The photosensitive body according to claim 4, wherein the amount of the polysiloxane is equal to or less than about 1.33 parts by weight per 1 part of the urethane oligomer-based compound by weight.

6. The photosensitive body according to claim 4, wherein the amount of the polysiloxane is equal to or less than about 0.67 parts by weight per 1 part of the urethane oligomer-based compound by weight.

7. A photosensitive body for an image forming apparatus and including a photosensitive layer, comprising:
a protective layer formed on the photosensitive layer, the protective layer including
a urethane oligomer-based compound including urethane oligomer acrylates, and
a polysiloxane having a chemical structure represented by the following Formulae 1: 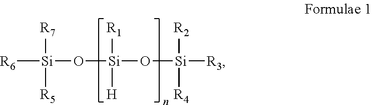
where R1 through R7 each independently represents a hydrogen atom, or an alkyl group which has 1 to 25 carbons, or an alkoxy group which has 1-10 carbons, where n represents an integer greater than or equal to 1, and where H represents a hydrogen atom.

8. The photosensitive body according to claim 7, wherein the R1 through the R7 each represents a methyl group.

9. The photosensitive body according to claim 8, wherein
an amount of the polysiloxane is more than about 0.03 parts by weight and less than 1.67 parts by weight per 1 part of the urethane oligomer-based compound by weight.

10. The photosensitive body according to claim 9, wherein the amount of the polysiloxane is equal to or less than about 1.33 parts by weight per 1 part of the urethane oligomer-based compound by weight.

11. The photosensitive body according to claim 9, wherein the amount of the polysiloxane is equal to or less than about 0.67 parts by weight per 1 part of the urethane oligomer-based compound by weight.

12. A cartridge couplable to an image forming apparatus, comprising:
a photosensitive body including:
a photosensitive layer; and
a protective layer formed on the photosensitive layer, the protective layer including:
a urethane oligomer-based compound including urethane oligomer acrylates, and
a polysiloxane including a silicon atom (Si) covalently bonded to a first side chain including an oxygen atom (O) covalently bonded to the urethane oligomer-based compound, the polysiloxane having a chemical structure represented by the following Formulae 1: 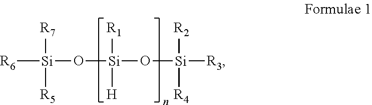
where R1 through R7 each independently represents a hydrogen atom, or an alkyl group which has 1 to 25 carbons, or an alkoxy group which has 1-10 carbons, where n represents an integer greater than or equal to 1, and where each respective H independently represents a hydrogen atom or the oxygen atom (O) covalently bonded to the urethane oligomer-based compound.

13. The cartridge according to claim 12, wherein
the R1 through the R7 each represents a methyl group, and
an amount of the polysiloxane is more than about 0.03 parts by weight and less than 1.67 parts by weight per 1 part of the urethane oligomer-based compound by weight.

14. The cartridge according to claim 13, wherein the amount of the polysiloxane is equal to or less than about 1.33 parts by weight per 1 part of the urethane oligomer-based compound by weight.

15. The cartridge according to claim 13, wherein the amount of the polysiloxane is equal to or less than about 0.67 parts by weight per 1 part of the urethane oligomer-based compound by weight.
